(19) United States
(12) Patent Application Publication
(10) Pub. No.: US 2014/0274067 A1
(43) Pub. Date: Sep. 18, 2014

(54) MOBILE TERMINAL, CONTROL METHOD, AND COMMUNICATION SYSTEM

(71) Applicant: FUJITSU LIMITED, Kawasaki-shi (JP)

(72) Inventor: NARITOSHI SAITO, Hino (JP)

(73) Assignee: FUJITSU LIMITED, Kawasaki-shi (JP)

(21) Appl. No.: 14/138,283

(22) Filed: Dec. 23, 2013

(30) Foreign Application Priority Data
Mar. 18, 2013 (JP) 2013-055686

(51) Int. Cl. H04W 36/32

(52) U.S. Cl. CPC H04W 36/32
USPC 455/441

(57) ABSTRACT

A mobile terminal includes a receiving unit that is configured to enable reception of a wireless signal by concurrently using a first cell of a first frequency bandwidth and a second cell of a second frequency bandwidth that is different from the first frequency bandwidth, the second cell having a range that is smaller than the first cell; and a processor that is configured to detect a movement speed of the mobile terminal, and shift the receiving unit to a second state when the detected movement speed falls below a predetermined speed during a first state in which the receiving unit receives the wireless signal by using at least the first cell, the second state being a state in which the receiving unit receives the wireless signal by using the second cell without using the first cell.

### CROSS REFERENCE TO RELATED APPLICATIONS

This application is based upon and claims the benefit of priority of the prior Japanese Patent Application No. 2013-055686, filed on Mar. 18, 2013, the entire contents of which are incorporated herein by reference.

### FIELD

The embodiment discussed herein is related to a mobile terminal, a control method, and a communication system.

### BACKGROUND

Long Term Evolution (LTE) and LTE-Advanced (LTE-A) are conventionally known mobile communication schemes. Under LTE and LTE-A, for example, Orthogonal Frequency Division Multiplexing Access (OFDMA) is used.

Under LTE-A, carrier aggregation (CA), which bundles and uses multiple component carriers (CC), is employed. The carrier aggregation includes selecting a primary cell (main cell) and a secondary cell (sub-cell), for example. For the primary cell, for example, a wide-area cell is selected that uses a frequency bandwidth called a platinum bandwidth, which enables easy signal reception.

According to a known technique, reductions in handover processing for a terminal is achieved by using a virtual wireless identifier as a common ID at multiple base stations (see, e.g., Japanese Laid-Open Patent Publication No. 2012-019348). According to another known technique, a mobile terminal concurrently uses a first carrier of a first frequency bandwidth and a second carrier of a second frequency bandwidth that is of a higher frequency bandwidth than the first frequency bandwidth, so as to transmit and receive signals with respect to a wireless base station (see, e.g., Japanese Laid-Open Patent Publication No. 2011-142596). According to yet another known technique, during communication with a wireless communication terminal in a microcell, the communication is switched to communication using a macrocell in response to reception timing of a signal transmitted from the wireless communication terminal (see, e.g., Japanese Laid-Open Patent Publication No. 2010-147848).

However, in the conventional techniques described above, terminals continuously use a wide-area cell as the primary cell even when communication is stabilized without using the wide-area cell and therefore, the wide-area cell is congested while a small-area cell is not used in some cases. This is problematic in that communication resources are used efficiently.

### SUMMARY

According to an aspect of an embodiment, a mobile terminal includes a receiving unit that is configured to enable reception of a wireless signal by concurrently using a first cell of a first frequency bandwidth and a second cell of a second frequency bandwidth that is different from the first frequency bandwidth, the second cell having a range that is smaller than the first cell; and a processor that is configured to detect a movement speed of the mobile terminal, and shift the receiving unit to a second state when the detected movement speed falls below a predetermined speed during a first state in which the receiving unit receives the wireless signal by using at least the first cell, the second state being a state in which the receiving unit receives the wireless signal by using the second cell without using the first cell.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a diagram of an example of a communication system according to an embodiment;

FIG. 1B is a diagram of an example of signal flow in the communication system depicted in FIG. 1A;

FIG. 1C depicts an example of cells that can be used by a mobile terminal to receive a wireless signal;

FIG. 2 is a diagram of an example of carrier aggregation;

FIG. 3 is a diagram of an example of frame mapping of a downlink physical channel;

FIG. 4 is a sequence diagram of an example of message flow between a mobile terminal and a network;

FIGS. 5, 6, and 7 are flowcharts of an example of operation of the mobile terminal;

FIG. 8A is a diagram of an example of a first event group;

FIG. 8B is a diagram of an example of a second event group;

FIG. 9A is a diagram of an example of a hardware configuration of the mobile terminal; and

FIG. 9B is a diagram of an example of signal flow in the hardware configuration of the mobile terminal depicted in FIG. 9A.

### DESCRIPTION OF EMBODIMENTS

Embodiments of a mobile terminal, a control method, and a communication system will be described in detail with reference to the accompanying drawings.

FIG. 1A is a diagram of an example of a communication system according to an embodiment. FIG. 1B is a diagram of an example of signal flow in the communication system depicted in FIG. 1A. FIG. 1C depicts an example of cells that can be used by a mobile terminal to receive a wireless signal.

As depicted in FIGS. 1A and 1B, a communication system 100 according to the embodiment includes a mobile terminal 110 and a base station 120. The mobile terminal 110 performs wireless communication with the base station 120. The base station 120 may be present in plural.

Cells 131, 132, and a cell group 133 depicted in FIG. 1C are cells that can be used by the mobile terminal 110 to receive wireless signals. The cells 131 and 132 are cells that use a first frequency bandwidth b1. The cell group 133 is made up of cells that use a second frequency bandwidth b2 that is different from the first frequency bandwidth b1. As depicted in FIG. 1C, the cells of the cell group 133 are cells that overlap at least any one among the cells 131 and 132, and cover a range (coverage area) that is smaller than the cells 131 and 132.

As depicted in FIGS. 1A and 1B, the mobile terminal 110 includes a receiving unit 111, a detecting unit 112, and a setting unit 113. The receiving unit 111 receives wireless signals from the base station 120. The receiving unit 111 can receive the wireless signals by concurrently using a cell of the first frequency bandwidth b1 (e.g., either of the cells 131 and 132) and a cell of the second frequency bandwidth b2 (e.g., any cell in the cell group 133) depicted in FIG. 1C.

The receiving unit 111 may be set to a first state in which wireless signals are received by using at least a cell of the first frequency bandwidth b1 and a second state in which wireless signals are received by using a cell of the second frequency bandwidth b2 without using a cell of the first frequency bandwidth b1. In the first state, for example, the receiving unit 111 receives wireless signals by concurrently using a cell of the first frequency bandwidth b1 and a cell of the second frequency bandwidth b2. In the second state, for example, the receiving unit 111 receives wireless signals by concurrently using multiple cells of the second frequency bandwidth b2.

A cell of the second frequency bandwidth b2 is a cell covering a range that is smaller than that of a cell of the first frequency bandwidth b1 and therefore, if the mobile terminal 110 moves at high speed, communication quality deteriorates more frequently and, for example, communication is interrupted more frequently in a cell of the second frequency bandwidth b2 as compared to a cell of the first frequency bandwidth b1.

The detecting unit 112 detects the movement speed of the mobile terminal 110 (the terminal of the detecting unit 112). The detecting unit 112 outputs a result of the detection to the setting unit 113.

The setting unit 113 sets a cell that is to be used by the receiving unit 111, from among the cells of the first frequency bandwidth b1 and the second frequency bandwidth b2. Based on the detection result output from the detecting unit 112, if the movement speed of the mobile terminal 110 falls below a predetermined speed when the receiving unit 111 is in the first state, the setting unit 113 shifts the receiving unit 111 to the second state.

As a result, during low-speed movement or during a stop when communication is stabilized even in a smaller cell, the wireless signal can be received without using a cell of the wide-area first frequency bandwidth b1. Thus, the wide-area first frequency bandwidth b1 can be made available for other terminals with unstable communication such as a mobile terminal moving at high speed, thereby enabling communication resources to be used efficiently.

After shifting the receiving unit 111 to the second state, if the movement speed of the mobile terminal 110 becomes greater than or equal to the predetermined speed, the setting unit 113 may shift the receiving unit 111 to the first state. As a result, if the mobile terminal 110 starts moving at high speed, a shift can be made to the communication using the wide-area first frequency bandwidth b1 to avoid unstable communication.

For example, the setting unit 113 transmits to the base station 120, request information requesting that wireless signals be received by using a cell of the second frequency bandwidth b2 without using a cell of the first frequency bandwidth b1. The setting unit 113 receives instruction information instructing that wireless signals are to be received by using a cell of the second frequency bandwidth b2 without using a cell of the first frequency bandwidth b1, whereby the receiving unit 111 shifts from the first state to the second state.

Upon receiving the request information from the mobile terminal 110, the base station 120 determines whether an instruction is to be made to instruct the mobile terminal 110 to receive wireless signals by using a cell of the second frequency bandwidth b2 without using a cell of the first frequency bandwidth b1. If it is determined that the instruction is to be made, the base station 120 transmits to the mobile terminal 110, instruction information instructing that wireless signals are to be received by using a cell of the second frequency bandwidth b2 without using a cell of the first frequency bandwidth b1.

Upon receiving the request information from the mobile terminal 110, the base station 120 transmits the received request information to a high-order system (e.g., EUTRAN 410 described later). The base station 120 receives from the high-order system, instruction information instructing the mobile terminal 110 to receive wireless signals by using a cell of the second frequency bandwidth b2 without using a cell of the first frequency bandwidth b1, and transmits the received instruction information to the mobile terminal 110.

Setting based on reception quality will be described. The mobile terminal 110 may include a measuring unit 114. The measuring unit 114 measures reception quality for the cells (including sectors) of the first frequency bandwidth b1 and the second frequency bandwidth b2. The measurement of reception quality by the measuring unit 114 is a cell search that measures path loss for each cell, for example. The measuring unit 114 outputs results of the measurement to the setting unit 113.

The reception quality measured by the measuring unit 114 is, for example, Received Signal Strength Indicator (RSSI) or Carrier to Interference and Noise Ratio (CINR).

Configuration may be such that even when the movement speed of the mobile terminal 110 is lower than the predetermined speed, if the reception quality of the second frequency bandwidth b2 measured by the measuring unit 114 is less than or equal to a predetermined quality, the setting unit 113 does not shift the receiving unit 111 to the second state. As a result, the reception quality of the mobile terminal 110 can be prevented from deteriorating due to shifting to communication that uses only the second frequency bandwidth b2 even though the reception quality of the second frequency bandwidth b2 is low.

Further, configuration may be such that after shifting the receiving unit 111 to the second state, even when the movement speed becomes greater than or equal to the predetermined speed, if the reception quality exceeds the predetermined quality, the setting unit 113 does not shift the receiving unit 111 to the first state. As a result, the wide-area first frequency b1 to be used by a mobile terminal moving at high speed, etc. can be prevented from being pressured consequent to shifting to communication that uses the first frequency bandwidth b1 even though the reception quality of the second frequency bandwidth b2 is high in the mobile terminal 110.

Based on the detection result output from the detecting unit 112, if the movement speed of the mobile terminal 110 falls below a predetermined speed, the measuring unit 114 may terminate the measurement of reception quality of the first frequency bandwidth b1. As a result, if the receiving unit 111 is shifted to the second state by the setting unit 113 and the receiving unit 111 does not use the first frequency bandwidth b1, the measurement of reception quality of the first frequency bandwidth b1 can be terminated to curb the power consumption of the mobile terminal 110. Therefore, for example, the battery life of the mobile terminal 110 can be improved.

After terminating first measurement, if the movement speed of the mobile terminal 110 becomes greater than or equal to the predetermined speed, the measuring unit 114 may resume the first measurement. As a result, if the mobile terminal 110 starts moving at high speed, a shift can be made to communication that uses a cell of the first frequency bandwidth b1 selected based on the measurement result of the reception quality of the first frequency bandwidth b1 to stabilize the communication.

The communication system 100 is applicable to a communication system capable of wireless communication such as LTE, LTE-A, and via a wireless local area network (LAN), for example. A case where the communication system 100 is applied to a communication system capable of LTE-A wireless communication will be described hereinafter.

FIG. 2 is a diagram of an example of carrier aggregation. The horizontal axis of FIG. 2 indicates frequency. Bandwidth A depicted in FIG. 2 is a frequency bandwidth from 650 [MHz] to 970 [MHz]. Bandwidth B is a frequency bandwidth from 3.2 [GHz] to 3.8 [GHz]. The carrier aggregation under LTE-A is performed by, for example, four component carriers including one component carrier 210 in bandwidth A and three component carries 221 to 223 in bandwidth B.

In this case, when it is assumed that a bandwidth of each of the component carriers 210 and 221 to 223 is 20 [MHz], a service can be performed with up to 80 [MHz] in width. Such carrier aggregation is referred to as inter frequency carrier aggregation, for example.

Bandwidth A of the lower frequency bandwidth is referred to as a platinum bandwidth (main band), for example, and is a frequency bandwidth in which signal reception is easy as compared to bandwidth B. Therefore, a cell using bandwidth A has a wider coverage area and is referred to as a macrocell, for example. The coverage area of a macrocell has a radius of about 1 [km], for example.

Bandwidth B of the higher frequency bandwidth is referred to as an advanced bandwidth (expanded bandwidth), for example, and is a frequency bandwidth in which signal reception is less easily as compared to bandwidth A. Therefore, a cell using bandwidth B has a smaller coverage area and is referred to as a microcell, for example. The coverage area of a microcell has a radius of about 100 [km], for example.

The first frequency bandwidth b1 depicted in FIG. 1C corresponds to bandwidth A depicted in FIG. 2, for example. The second frequency bandwidth b2 depicted in FIG. 1C corresponds to bandwidth B depicted in FIG. 2, for example. During low-speed movement or during a stop, the mobile terminal 110 uses, for example, the component carrier 210 of bandwidth A as a primary component carrier (primary CC) and uses the component carriers 221 to 223 of bandwidth B as secondary component carriers (secondary CCs). In this case, for the mobile terminal 110, a primary cell is a cell that uses the component carrier 210 and a secondary cell is a cell that uses the component carriers 221 to 223.

During high-speed movement, the mobile terminal 110 uses, for example, the component carriers 221 to 223 of bandwidth B as the primary and secondary CCs. In this case, for the mobile terminal 110, the primary cell and the secondary cell are cells that use the component carriers 221 to 223.

FIG. 3 is a diagram of an example of frame mapping of a downlink physical channel. In FIG. 3, the horizontal direction indicates time and the vertical direction indicates frequency. The frame 310 represents one frame in the downlink physical channel in the mobile terminal 110. A length of the frame 310 is 10 [ms] and the frame 310 is repeatedly transmitted in the downlink physical channel. The frame 310 includes 10 sub-frames having a length of 1 [ms].

A sub-frame 320 represents one sub-frame in the frame 310. The sub-frame 320 includes two slots. A slot 330 represents one slot in the sub-frame 320. The slot 330 includes seven OFDM symbols. Each OFDM symbol of the slot 330 includes at the beginning a cyclic prefix (CP) that is a copy of an end portion of each symbol.

The sub-frame 320 includes, for example, a primary synchronization signal 321, a secondary synchronization signal 322, a physical broadcast channel (PBCH) 323, a physical downlink control channel (PDCCH) 324, a physical downlink shared channel (PDSCH) 325, and a reference signal (RS) 326. At the time of a cell search, the mobile terminal 110 executes a synchronization process by using the primary synchronization signal 321 and the secondary synchronization signal 322, thereby demodulating the cell ID to identify the cell.

The mobile terminal 110 measures RSSI, Reference Signal Received Power (RSRP), and Reference Signal Received Quality (RSRQ) based on 3GPP Specification 36.214 under LTE-A, for example.

The measurement of RSSI is by wireless power measurement such as wireless power measurement of a signal with noise and interference components added in addition to a cell signal. The measurement of RSRP is by power measurement of the reference signal 326, for example. The reference signal 326 is mapped to symbol “0” and symbol “4” in each slot.

For example, RSRQ is acquired by dividing RSRP, which is power of the reference signal 326, by RSSI, and corresponds to Signal to Interference and Noise Ratio (SINR), for example.

The mobile terminal 110 may measure CINR.

FIG. 4 is a sequence diagram of an example of message flow between the mobile terminal and a network. The Evolved Universal Terrestrial Radio Access Network (EUTRAN) 410 depicted in FIG. 4 is provided at the base station 120, for example. The EUTRAN 410 may be provided in a higher-order communication apparatus than the base station 120. In this case, the mobile terminal 110 communicates with the EUTRAN 410, via the base station 120.

Under LTE-A (e.g., 3GPP TS36.331), for example, the following steps are periodically executed. First, the mobile terminal 110 transmits a measurement report to the EUTRAN 410 (step S401). The measurement report includes information based on measurement results of RSSI, RSRP, and RSRQ from the cell search described above, for example.

The EUTRAN 410 determines details of a setting change for the mobile terminal 110 (including “no change”) based on the measurement report transmitted at step S401 (step S402). The setting change may be, for example, a change of the primary CC from the platinum bandwidth to the advanced bandwidth, addition or cancelation of a secondary CC, etc. The EUTRAN 410 transmits to the mobile terminal 110, a RRC connection reconfiguration including information indicating details of the setting change determined at step S402 (step S403).

The mobile terminal 110 makes the setting change based on the RRC connection reconfiguration transmitted at step S403 (step S404). The mobile terminal 110 transmits to the EUTRAN 410, “RRC connection reconfiguration complete” indicating the completion of the setting change (step S405) and terminates a sequence of the message flow.

According to the operations above, the EUTRAN 410 determines a setting change for the mobile terminal 110 based on the results of periodical cell searches in the mobile terminal 110, and the setting change of the mobile terminal 110 is performed according to the determination result.

FIGS. 5, 6, and 7 are flowcharts of an example of operation of the mobile terminal. When powered on, the mobile terminal 110 executes the operations depicted in FIGS. 5 to 7, for example. First, as depicted in FIG. 5, the mobile terminal 110 performs a primary cell search for detecting the primary cell using the primary CC having good reception performance (step S501). The primary cell search is a cell search for the component carrier 210 (primary CC) depicted in FIG. 2, for example. The primary cell search at step S501 may be a cell search for detecting the primary cell set when the mobile terminal 110 was powered off last, for example.

The mobile terminal 110 starts communication by using the primary cell detected at step S501 (step S502). The mobile terminal 110 acquires secondary CC information through dedicated signaling via the primary cell detected at step S501 (step S503). The secondary CC information is information indicating the frequency bandwidth of the secondary CC, for example.

The mobile terminal 110 sets a platinum bandwidth no-measurement flag to “0” (step S504). The platinum bandwidth no-measurement flag is set to “1” if no cell search is performed for a platinum bandwidth (e.g., bandwidth A of FIG. 2) and set to “0” if a secondary cell search is performed. The mobile terminal 110 then proceeds to steps depicted in FIG. 6 (reference numeral A). In particular, the mobile terminal 110 performs the primary cell search (step S601).

The mobile terminal 110 determines whether the platinum bandwidth no-measurement flag is “1” (step S602). If the platinum bandwidth no-measurement flag is not “1” (step S602: NO), the mobile terminal 110 performs the secondary cell search for the platinum bandwidth and the advanced bandwidth (e.g., bandwidth B of FIG. 2) (step S603) and proceeds to step S605.

If the platinum bandwidth no-measurement flag is “1” at step S602 (step S602: YES), the mobile terminal 110 performs the secondary cell search for the advanced bandwidth (step S604) and does not perform the secondary cell search for the platinum bandwidth.

The mobile terminal 110 determines whether the movement speed Vm of the mobile terminal 110 is lower than a threshold value Vth1 (step S605). The threshold value Vth1 may be set to 15 [km/h], for example. If the movement speed Vm is lower than the threshold value Vth1 (step S605: YES), the mobile terminal 110 checks a first event group (see, e.g., FIG. 8A) (step S606) and proceeds to step S609.

If the movement speed Vm is not lower than the threshold value Vth1 at step S605 (step S605: NO), the mobile terminal 110 sets the platinum bandwidth no-measurement flag to “0” (step S607). The mobile terminal 110 checks a second event group (see, e.g., FIG. 8B) (step S608).

The mobile terminal determines whether the occurrence of an event has been detected by the check at step S606 or step S608 (step S609). If no occurrence of an event is detected (step S609: NO), the mobile terminal 110 sets a timer T1 that times a predetermined period (step S610).

The mobile terminal 110 determines whether the timer T1 set at step S610 has expired (step S611) and if not, waits for the timer T1 to expire (step S611: NO). When the timer T1 expires (step S611: YES), the mobile terminal 110 returns to step S601.

If the occurrence of an event has been detected at step S609 (step S609: YES), the mobile terminal 110 uses the primary cell to report the detected event to the network through a measurement report (step S612). The network is the EUTRAN 410 depicted in FIG. 4, for example.

The mobile terminal 110 determines whether a RRC connection reconfiguration (RRC_Conn_Recf) has been received from the network (step S613). If RRC_Conn_Recf has not been received (step S613: NO), the mobile terminal 110 proceeds to step S610.

If RRC_Conn_Recf has been received at step S613 (step S613: YES), the mobile terminal 110 proceeds to the operations depicted in FIG. 7 (reference character B). In particular, the mobile terminal 110 determines whether the received RRC_Conn_Recf is an instruction for setting the advanced bandwidth as the primary CC (step S701).

At step S701, if the RRC_Conn_Recf is not an instruction for setting the advanced bandwidth as the primary CC (step S701: NO), the mobile terminal 110 proceeds to step S704. If the RRC_Conn_Recf is an instruction for setting the advanced bandwidth as the primary CC (step S701: YES), the mobile terminal 110 sets the advanced bandwidth as the primary CC (step S702). The mobile terminal 110 sets the platinum bandwidth no-measurement flag to “1” (step S703).

The mobile terminal 110 determines if the received RRC_Conn_Recf is an instruction for the addition or cancellation of a secondary CC (step S704). If RRC_Conn_Recf is not an instruction for the addition or cancellation of a secondary CC (step S704: NO), the mobile terminal 110 proceeds to step S706. If RRC_Conn_Recf is an instruction for the addition or cancellation of a secondary CC (step S704: YES), the mobile terminal 110 adds or deletes a secondary CC according to the RRC_Conn_Recf (step S705).

The mobile terminal 110 sets the timer T1 that times a predetermined period (step S706). The mobile terminal 110 determines whether the timer T1 set at step S706 has expired (step S707) and if not, waits for the timer T1 to expire (step S707: NO). When the timer T1 expires at step S707 (step S707: YES), the mobile terminal 110 returns to step S601 depicted in FIG. 6 (reference character A).

By the operations depicted in FIGS. 5 to 7, the mobile terminal 110 checks events for each period timed by the timer T1 and if the occurrence of an event is detected, the mobile terminal 110 makes a report to the network and performs a setting change if an instruction for a setting change is issued by the network.

If the mobile terminal 110 is not moving at high speed, the mobile terminal 110 can check the first event group and change the primary CC from the platinum bandwidth to the advanced bandwidth depending on the result. If the primary CC is set to the advanced bandwidth, the mobile terminal 110 can refrain from performing a cell search of the platinum bandwidth.

If the mobile terminal 110 is moving at high speed, the mobile terminal 110 can check the second event group and thereby, refrain from changing the primary CC from the platinum bandwidth to the advanced bandwidth.

After changing the primary CC from the platinum bandwidth to the advanced bandwidth, if the mobile terminal 110 is no longer moving at high speed, the mobile terminal 110 can resume the cell search for the platinum bandwidth. As a result, for example, if the power of the platinum bandwidth (neighbour cell) becomes higher than a threshold value (e.g., “Event A4” described later), the mobile terminal 110 can make a report to the EUTRAN 410 to change the primary CC from the advanced bandwidth to the platinum bandwidth.

The period timed by the timer T1 can be set to about 30 seconds to 180 seconds to reflect the movement speed, the remaining battery amount, etc. of the mobile terminal 110, for example.

FIG. 8A is a diagram of an example of the first event group. The first event group checked at step S606 of FIG. 6 is an event group described in a table 810 depicted in FIG. 8A, for example. In other words, the event group described in the table 810 is an event group that is checked when the mobile terminal 110 is not moving at high speed. As depicted in the table 810, the first event group includes “Event A1” to “Event A6”, “Event B1”, “Event B2”, and “Event C1”.

“Event A1” to “Event A6”, “Event B1”, and “Event B2” are events defined under TS36.331 of 3rd Generation Partnership Project (3GPP), for example. “Event C1” is an additional event for the events defined under TS36.331.

“Event A1” is an event occurring when power of a serving cell becomes better than a threshold value. “Event A2” is an event occurring when the power of a serving cell becomes lower than a threshold value. “Event A3” is an event that occurs when the power of a neighbour cell becomes better than an offset determined by comparison with the primary cell.

“Event A4” is an event that occurs when the power of a neighbour cell becomes better than a threshold value. “Event A5” is an event that occurs when the power of the primary cell becomes lower than a threshold value and the power of a neighbour cell becomes better than a threshold value. “Event A6” is an event that occurs when the power of a neighbour cell becomes better than an offset determined by comparison with the power of the secondary cell.

“Event B1” is an event that occurs when the power of an Inter RAT (another wireless system) neighbour cell becomes better as compared to a threshold value. “Event B2” is an event that occurs when the power of the primary cell becomes lower than a threshold value and power of an Inter RAT (another wireless system) neighbour cell becomes better than a threshold value.

If the primary CC of the mobile terminal 110 is the platinum bandwidth and the mobile terminal 110 is not moving at high speed, “Event C1” is checked to release the platinum bandwidth from the mobile terminal 110. “Event C1” is an event that occurs when the CINR of the secondary CC of the advanced bandwidth is better than a predetermined threshold value.

If “Event C1” occurs, the mobile terminal 110 transmits to the EUTRAN 410 through a measurement report, information requesting that the advanced bandwidth be set as the primary CC. In other words, the information requesting that the advanced bandwidth be set as the primary CC is information requesting that the mobile terminal 110 receive wireless signals by using a cell of the advanced bandwidth rather than using a cell of the platinum bandwidth.

FIG. 8B is a diagram of an example of the second event group. The second event group checked at step S608 of FIG. 6 is an event group described in a table 820 depicted in FIG. 8B, for example. In other words, the event group described in the table 820 is an event group that is checked when the mobile terminal 110 is moving at high speed. As depicted in the table 820, the second event group includes “Event A1” to “Event A6”, “Event B1”, and “Event B2”. The second event group does not include “Event C1”, which is included in the first event group depicted in FIG. 8A.

As described above, if the mobile terminal 110 is moving at high speed, the mobile terminal 110 refrains from checking “Event C1”, which is for shifting the primary CC to the advanced bandwidth.

FIG. 9A is a diagram of an example of a hardware configuration of the mobile terminal. FIG. 9B is a diagram of an example of signal flow in the hardware configuration of the mobile terminal depicted in FIG. 9A. As depicted in FIGS. 9A and 9B, the mobile terminal 110 includes an antenna 901, an LTE-A device 910, a central processing unit (CPU) 921, memory 922, a display unit 931, an operating unit 932, a microphone 933, a speaker 934, and a terminal speed detecting unit 941.

The LTE-A device 910 is a communication circuit executing a communication process in the LTE-A mode. For example, the LTE-A device 910 has an LTE-A wireless unit 911 and an LTE-A baseband unit 912. According to the LTE-A scheme, the LTE-A wireless unit 911 wirelessly transmits, via the antenna 901, a transmission signal output from the LTE-A baseband unit 912. The LTE-A wireless unit 911 outputs to the LTE-A baseband unit 912, a reception signal received via the antenna 901 according to the LTE-A scheme.

The LTE-A baseband unit 912 executes a baseband process on a transmission signal output from the CPU 921 and outputs the transmission signal subjected to the baseband process to the LTE-A wireless unit 911. The LTE-A baseband unit 912 executes a baseband process on a reception signal output from the LTE-A wireless unit 911 and outputs the reception signal subjected to the baseband process to the CPU 921.

The CPU 921 is responsible for overall control of the mobile terminal 110. For example, the operations depicted in FIGS. 5 to 7 are executed by the CPU 921.

The memory 922 includes main memory and auxiliary memory, for example. The main memory is random access memory (RAM), for example. The main memory is used as a work area of the CPU 921. The auxiliary memory is non-volatile memory such as a magnetic disk and a flash memory. The auxiliary memory stores various programs for operating the mobile terminal 110. The programs stored in the auxiliary memory are loaded to the main memory and executed by the CPU 921.

The display unit 931 displays information for a user of the mobile terminal 110, under the control of the CPU 921. The display unit 931 may be implemented by a liquid crystal display, for example. The operating unit 932 is manipulated by the user of the mobile terminal 110 and notifies the CPU 921 of the details of the manipulation. The operating unit 932 may be implemented by switches and keys, for example. The display unit 931 and the operating unit 932 may be implemented by a touch panel, etc. The microphone 933 receives audio input from the user and notifies the CPU 921 of the contents of the input received. The speaker 934 outputs sound to the user of the mobile terminal 110, under the control of the CPU 921.

The terminal speed detecting unit 941 detects the movement speed of the mobile terminal 110. The terminal speed detecting unit 941 detects the movement speed by using an acceleration sensor, for example.

However, this is not a limitation of the detection of the movement speed by the terminal speed detecting unit 941 and various methods are available. For example, the terminal speed detecting unit 941 may detect the movement speed based on the frequency and phase of a signal received by the antenna 901.

The terminal speed detecting unit 941 may acquire positional information of the mobile terminal 110 via a Global Positioning System (GPS), etc. to detect the movement speed based on a change in the positional information. The terminal speed detecting unit 941 may detect the movement speed based on a change of the base station communicating with the mobile terminal 110.

The terminal speed detecting unit 941 may be implemented by an electronic circuit etc., different from the CPU 921, for example. Alternatively, the terminal speed detecting unit 941 may be implemented by executing a program on the CPU 921, for example.

The receiving unit 111 depicted in FIGS. 1A and 1B may be implemented by the antenna 901 and the LTE-A device 910, for example. The measuring unit 114 depicted in FIGS. 1A and 1B may be implemented by the antenna 901, the LTE-A device 910, and the CPU 921, for example.

The setting unit 113 depicted in FIGS. 1A and 1B may be implemented by the LTE-A device 910 and the CPU 921, for example. The detecting unit 112 depicted in FIGS. 1A and 1B may be implemented by the terminal speed detecting unit 941, for example.

As described above, according to the mobile terminal, the control method, and the communication system, communication resources are be used efficiently. As a result, for example, user capacity of a wireless system can be improved.

For example, since conventional LTE-A allows even a terminal with slow movement speed to continuously use the platinum bandwidth as the primary CC, the platinum bandwidth is always congested and quality is frequently reduced. For example, although a mobile terminal moving at high speed must rely on the platinum bandwidth, deterioration in the quality of the platinum bandwidth reduces the quality of wireless service.

In contrast, the mobile terminal 110 can shift the primary CC from the platinum bandwidth to the expanded bandwidth during low-speed movement or during a stop when communication is stabilized even with the expanded bandwidth, thereby making the platinum bandwidth available for a mobile terminal that is moving at high speed, etc. Consequently, communication resources are used efficiently, thereby improving the communication quality in the communication system 100.

An aspect of the present invention enables communication resources to be used efficiently.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A mobile terminal comprising:
a receiving unit that is configured to enable reception of a wireless signal by concurrently using a first cell of a first frequency bandwidth and a second cell of a second frequency bandwidth that is different from the first frequency bandwidth, the second cell having a range that is smaller than the first cell; and
a processor that is configured to:
detect a movement speed of the mobile terminal, and
shift the receiving unit to a second state when the detected movement speed falls below a predetermined speed during a first state in which the receiving unit receives the wireless signal by using at least the first cell, the second state being a state in which the receiving unit receives the wireless signal by using the second cell without using the first cell.

2. The mobile terminal according to claim 1, wherein
the processor shifts the receiving unit from the first state to the second state by transmitting to a base station, request information requesting that the receiving unit receive the wireless signal by using the second cell without using the first cell, and receiving from the base station, instruction information instructing that the receiving unit receive the wireless signal by using the second cell without using the first cell.

3. The mobile terminal according to claim 1, wherein
the processor, after shifting the receiving unit to the second state, shifts the receiving unit to the first state when the detected movement speed becomes at least the predetermined speed.

4. The mobile terminal according to claim 1, wherein
the processor is further configured to measure reception quality for each cell of the second frequency bandwidth, and
the processor shifts the receiving unit to the second state when the movement speed is lower than the predetermined speed and the measured reception quality is greater than a predetermined quality, and refrains from shifting the receiving unit to the second state when the movement speed is lower than the predetermined speed and the reception quality is at most the predetermined quality.

5. The mobile terminal according to claim 4, wherein
the processor, after shifting the receiving unit to the second state, shifts the receiving unit to the first state when the detected movement speed becomes at least the predetermined speed and the measured reception quality is at most the predetermined quality, and refrains from shifting the receiving unit to the first state when the movement speed becomes at least the predetermined speed and the reception quality exceeds the predetermined quality.

6. The mobile terminal according to claim 1, wherein
the processor is further configured to perform a first measurement of reception quality for each cell of the first frequency bandwidth and a second measurement of reception quality for each cell of the second frequency bandwidth,
the processor sets based on an obtained measurement result, a cell to be used by the receiving unit for receiving the wireless signal, and
the processor terminates the first measurement when the movement speed falls below the predetermined speed.

7. The mobile terminal according to claim 6, wherein
the processor, after terminating the first measurement, resumes the first measurement when the detected movement speed becomes at least the predetermined speed.

8. A control method of a mobile terminal that is configured to enable reception of a wireless signal by concurrently using a first cell of a first frequency bandwidth and a second cell of a second frequency bandwidth that is different from the first frequency bandwidth, the second cell having a range that is smaller than the first cell, the control method comprising:
detecting a movement speed of the mobile terminal, and
shifting the mobile terminal to a second state when the detected movement speed falls below a predetermined speed during a first state in which the mobile terminal receives the wireless signal by using at least the first cell, the second state being a state in which the wireless signal is received by using the second cell without using the first cell.

9. A communication system comprising:
at least one base station that that is configured to transmit a wireless signal; and
a mobile terminal that is configured to enable reception of the wireless signal from the base station by concurrently using a first cell of a first frequency bandwidth and a second cell of a second frequency bandwidth that is different from the first frequency bandwidth, the second cell having a range that is smaller than the first cell, wherein
the mobile terminal detects a movement speed of the mobile terminal, and
the mobile terminal shifts to a second state when the detected movement speed falls below a predetermined speed during a first state in which the mobile terminal receives the wireless signal by using at least the first cell, the second state being a state in which the mobile terminal receives the wireless signal by using the second cell without using the first cell.

10. The communication system according to claim 9, wherein
the mobile terminal, when the movement speed falls below the predetermined speed, transmits to the base station, request information requesting that the mobile terminal receive the wireless signal by using the second cell without using the first cell,
the base station, if the request information is transmitted by the mobile terminal, transmits to the mobile terminal, instruction information instructing the mobile terminal to receive the wireless signal by using the second cell without using the first cell, and
the mobile terminal shifts from the first state to the second state based on the instruction information transmitted from the base station.
